(19) United States
(12) Patent Application Publication
(10) Pub. No.: US 2025/0001291 A1
(43) Pub. Date: Jan. 2, 2025

(54) COMPUTER SYSTEM, CYBERSPACE CONTROL SYSTEM, AND MANAGEMENT METHOD

(71) Applicant: BANDAI NAMCO ENTERTAINMENT INC., Tokyo (JP)

(72) Inventors: Takayoshi Oi, Tokyo (JP); Koji Asuna, Tokyo (JP); Kiyoshi Minami, Yokohama-shi (JP); Kenichi Ogura, Kodaira-shi (JP); Akio Onda, Warabi-shi (JP); Takashi Aoki, Funabashi-shi (JP); Shintaro Murai, Tokyo (JP)

(73) Assignee: BANDAI NAMCO ENTERTAINMENT INC., Tokyo (JP)

(21) Appl. No.: 18/885,960

(22) Filed: Sep. 16, 2024

Related U.S. Application Data
(63) Continuation of application No. PCT/JP2023/009094, filed on Mar. 9, 2023.

(30) Foreign Application Priority Data
Mar. 30, 2022 (JP) 2022-056820

(51) Int. Cl. A63F 13/352; A63F 13/75

(52) U.S. Cl. CPC A63F 13/352; A63F 13/75

(57) ABSTRACT

A portal server system manages a plurality of cyberspaces in which users can participate. Each cyberspace is associated with a participation disallowance condition including at least a condition that participation exceeding a given allowable number of participants is not allowed. The portal server system includes a participation possibility determination section that determines whether a user can participate in a cyberspace based on the participation disallowance condition associated with the cyberspace, and a participation allowed state setting section that, when a given specific user participating in a first cyberspace among the cyberspaces leaves the first cyberspace, sets the specific user to a participation allowed state in which the participation possibility determination section allows the specific user to participate in the first cyberspace.

### CROSS REFERENCE TO RELATED APPLICATIONS

This application is a continuation of International Patent Application No. PCT/JP2023/009094, having an international filing date of Mar. 9, 2023, which designated the United States, the entirety of which is incorporated herein by reference. Japanese Patent Application No.2022-056820 filed on Mar. 30, 2022 is also incorporated herein by reference in its entirety.

### BACKGROUND OF THE INVENTION

There is known a technique for constructing a virtual space (e.g., a metaverse, a game space of a multiplayer online game, etc.) that is a virtual world different from reality through computer calculation process, disposing the characters of participating users (e.g., avatars, player characters, etc.), and providing users with virtual experience in the virtual space.

In addition, when the number of users in a virtual space becomes large, it is impossible to manage and operate the users with one computer system. In other words, there is a limit to the number of users that can be accommodated in one virtual space. Therefore, in operating a multiplayer virtual space, a plurality of server systems are prepared, each server system controls a virtual space, and users are distributed and managed in a plurality of virtual spaces. In such a case, there is also known a technology on the assumption that users will move between virtual spaces. For example, there is a technique for determining the population density of each server and presenting it to the users (players) (refer to Japanese Unexamined Patent Application Publication No. 2010-213806). According to the technology of Japanese Unexamined Patent Application Publication No. 2010-213806, the user can leave the current virtual space and move to another virtual space with reference to the presented population density.

However, once a user has left a virtual space for purposes such as moving to another virtual space, the user cannot necessarily return to the original virtual space. For example, if the allowable number of participants (also called the capacity) is set for each virtual space so that the number of users does not exceed the limit, when the capacity becomes full while the user leaves, the user will not be able to participate in the virtual space. The same situation can occur not only in virtual spaces, but also in managing cyberspaces shared by a plurality of users. Cyberspace refers to a space shared by a plurality of users to realize communication among the users. An example other than virtual spaces is a chat room where participating users can have a conversation with each other.

### BRIEF DESCRIPTION OF THE DRAWINGS

FIG. 1 is a diagram illustrating an example of an overall configuration of a cyberspace control system.

FIG. 2 is a diagram for describing cyberspaces.

FIGS. 3A and 3B are diagrams for describing an overview of setting of a participation allowed state.

FIG. 4A and 4B are diagrams for describing an overview of setting of a participation allowed state.

FIG. 5 is a block diagram illustrating an example of a functional configuration of a portal server system.

FIG. 6 is a diagram illustrating an example of a data configuration of game server system management data.

FIG. 7 is a diagram illustrating an example of a data configuration of user management data.

FIG. 8 is a block diagram illustrating an example of a functional configuration of a game server system.

FIG. 9 is a functional block diagram illustrating an example of a functional configuration of a user terminal.

FIG. 10 is a flowchart illustrating a process flow in the portal server system.

FIG. 11 is a flowchart illustrating a process flow continued from FIG. 10.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising at least one processor or circuit programmed to execute:
managing a plurality of cyberspaces associated with a participation disallowance condition including at least a condition that participation by users in excess of a given allowable number of participants is disallowed;
performing a participation possibility determination for determining whether the users are allowed to participate in the cyberspaces based on the participation disallowance condition associated with the cyberspaces; and
when a given specific user participating in a first cyberspace among the cyberspaces leaves the first cyberspace, performing a participation allowed state setting control to set the participation of the specific user in the first cyberspace to a participation allowed state that is allowed by the participation possibility determination.

When the allowable number of participants in a cyberspace such as a virtual space or chat room to be joined is set and the number of participants is limited, the user cannot join a cyberspace in which the number of participants has already reached the allowable number of participants. According to the disclosure, in some embodiments, when a given specific user leaves the first cyberspace in which the specific user is participating, the specific user can be set to the participation allowed state that allows the specific user to participate in the first cyberspace. Therefore, even if the specific user leaves the first cyberspace in which the specific user is currently present for the purpose of participating in another cyberspace, the specific user can reliably participate in the first cyberspace if he/she wishes later. As a result, in some embodiments, it possible to provide a mechanism that allows users to easily move between a plurality of cyberspaces with a limited number of participants. The specific users may be some or all of the users participating in the first cyberspace.

A second disclosure is the computer system, wherein the plurality of cyberspaces are virtual spaces set in a common world view where the characters of participating users appear.

A third disclosure is the computer system as defined in claim 1, wherein the performing a participation possibility determination includes determining whether the specific user for which the participation allowed state was set by the participation allowed state setting control, is allowed to participate in a cyberspace other than the first cyberspace based on the participation disallowance condition associated with the cyberspace.

According to the disclosure, in some embodiments, even if the participation allowed state is set and the specific user leaves the first cyberspace, the specific user can still participate in the other cyberspace, in accordance with a determination based on the participation disallowance condition of the other cyberspace.

A fourth disclosure is the computer system, wherein the performing a participation possibility determination includes determining whether the user is allowed to participate in the first cyberspace while subtracting the number of specific users set in the participation allowed state from the allowable number of participants included in the participation disallowance condition associated with the first cyberspace.

According to the disclosure, in some embodiments, when a specific user who was set to the participation allowed state attempts to rejoin the first cyberspace at the time of leaving, it is possible to prevent a situation in which the number of participants in the first cyberspace reaches the allowable number of participants and the user is unable to participate, so that the user can reliably participate.

A fifth disclosure is the computer system, wherein the at least one processor or circuit is further programmed to execute performing specific user certification to certify a user who satisfies a given certification condition as the specific user.

According to the disclosure, in some embodiments, a user who satisfies the certification condition can be certified as the specific user for whom the participation allowed state is to be set.

A sixth disclosure is the computer system, wherein the performing specific user certification includes determining whether the user satisfies the certification condition based on any one of a duration of participation, the number of participation counts, and a frequency of participation in the first cyberspace.

According to the disclosure, in some embodiments, a user who leaves the first cyberspace can be certified as the specific user based on any one of the duration of participation, the number of participation counts, and the frequency of participation in the first cyberspace.

A seventh disclosure is the computer system, wherein the performing specific user certification includes determining whether the user satisfies the certification condition based on the user's action in the first cyberspace.

According to the disclosure, in some embodiments, a user who leaves the first cyberspace can be certified as the specific user based on the user's actions in the first cyberspace.

An eighth disclosure is the computer system,

wherein the at least one processor or circuit is further programmed to execute establishing a relationship between users, and

wherein the performing specific user certification includes determining whether the user satisfies the certification condition by using the relationship between the users.

According to the disclosure, in some embodiments, it is possible to certify the specific user by using the set relationship between the user who is leaving the first cyberspace and another user.

A ninth disclosure is the computer system, wherein the performing participation allowed state setting control includes canceling the setting of the participation allowed state for the specific user.

According to the disclosure, in some embodiments, the participation allowed state setting can be cancelled.

A tenth disclosure is the computer system, wherein the canceling includes determining whether to cancel the setting of the participation allowed state for the specific user based on a lapse time since the participation allowed state was set for the specific user or a lapse time since the specific user left the first cyberspace.

According to the disclosure, in some embodiments, the participation allowed state can be canceled based on the lapse time since the participation allowed state was set and the lapse time since the specific user related to the participation allowed state left the first cyberspace related to the participation allowed state.

An eleventh disclosure is the computer system, wherein the canceling includes canceling the setting of the participation allowed state for the specific user while the specific user is participating in a second cyberspace among the cyberspaces.

According to the disclosure, in some embodiments, the participation allowed state can be canceled while the specific user related to the participation allowed state is participating in the second cyberspace that is different from the first cyberspace related to the participation allowed state.

A twelfth disclosure is the computer system, wherein the canceling includes determining whether to cancel the setting of the participation allowed state for the specific user based on the time when the specific user participated in the second cyberspace or an action taken by the specific user in the second cyberspace.

According to the disclosure, in some embodiments, the participation allowed state can be released based on the time that the specific user related to the participation allowed state participated in the second cyberspace and the actions taken by the specific user in the second cyberspace.

A thirteenth disclosure is the computer system, wherein the at least one processor or circuit is further programmed to execute, after completion of the setting by the participation allowed state setting control, performing control to cause the specific user to leave the first cyberspace.

According to the disclosure, in some embodiments, after the setting of the participation allowed state is completed, the specific user related to the participation allowed state can be made to leave the first cyberspace related to the participation allowed state. As a result, in some embodiments, it possible to reliably set the participation allowed state.

A fourteenth disclosure is a cyberspace control system comprising:
a server system that is the computer system as defined above; and
a user terminal that acts as a man-machine interface for the user.

According to the disclosure, in some embodiments, it is possible to implement a cyberspace control system that has the same advantageous effects as any one of the first to thirteenth disclosures.

In accordance with one of some embodiments, there is provided a management method executed by a computer system, the method comprising:
managing a plurality of cyberspaces associated with a participation disallowance condition including at least a condition that participation by users in excess of a given allowable number of participants is disallowed;
performing a participation possibility determination for determining whether the users are allowed to participate in the cyberspaces based on the participation disallowance condition associated with the cyberspaces; and
when a given specific user participating in a first cyberspace among the cyberspaces leaves the first cyberspace, performing a participation allowed state setting control to set the participation of the specific user in the first cyberspace to a participation allowed state that is determined in the performing a participation possibility determination.

According to the disclosure, in some embodiments, it is possible to implement a management method that has the same advantageous effects as the first disclosure.

Exemplary embodiments are described below. Note that the following exemplary embodiments do not in any way limit the scope of the content defined by the claims laid out herein. Note also that all of the elements described in the present embodiment should not necessarily be taken as essential elements

Preferred embodiments of the present disclosure will be hereinafter described with reference to the drawings. In the following, a virtual space (a game space of a multiplayer online game) set in a common world view in which characters that can be considered avatars of participating users (hereinafter referred to as “user characters”) appear is exemplified as a cyberspace. However, the present disclosure is not limited by the following embodiments, and the modes to which the present disclosure is applicable are not limited to the following embodiments. In addition, common reference signs are given to identical components in the drawings.

### General Configuration

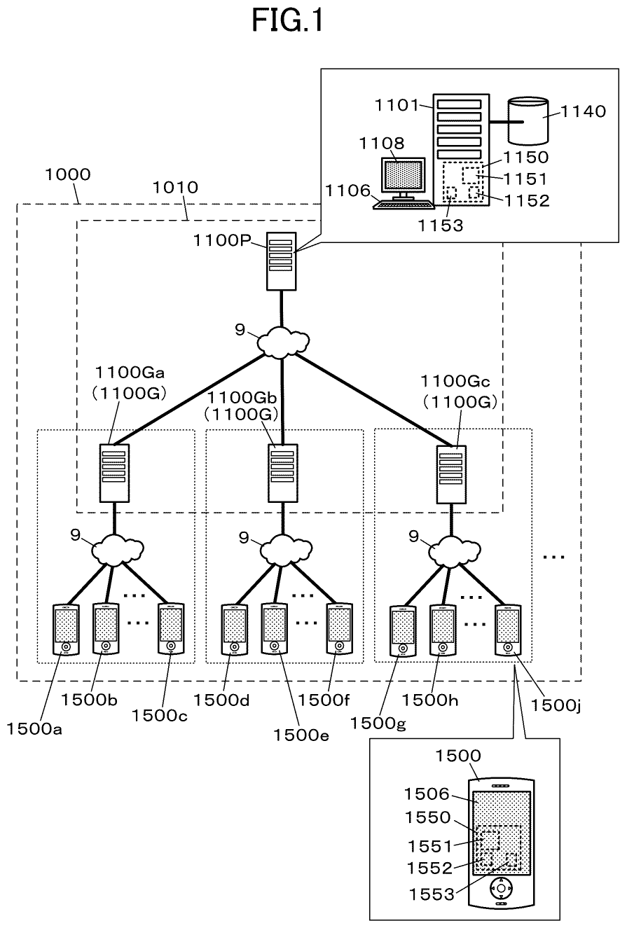

FIG. 1 is a diagram illustrating an example of the overall configuration of a cyberspace control system 1000. The cyberspace control system 1000 of the present embodiment is a system for providing users with a virtual experience in cyberspace as a multiplayer online game. As illustrated in FIG. 1, the cyberspace control system 1000 is a computer system that includes an operation system 1010 and user terminals 1500 (1500a, 1500b, . . . ) owned by users of the game of the present embodiment, which are connected via a network 9 so as to be capable of data communication.

The network 9 refers to a communication channel that allows data communication. That is, the network 9 includes a private line (private cable) for direct connection, a local area network (LAN) such as Ethernet (registered trademark), and communication networks such as a telecommunication network, a cable network, and the Internet. The communication method may be wired or wireless method.

The operation system 1010 is a computer system that is managed and operated by a service provider or a system operator, and includes a portal server system 1100P and a plurality of game server systems 1100G (1100Ga, 1100Gb, . . . ).

The portal server system 1100P is a server system that is first accessed by the user terminals 1500 in order to use various services relating to online games. The portal server system 1100P performs functions related to user registration, management of online sales of various items related to games, allocation of users to game servers, and the like, for example.

Each of the game server systems 1100G (1100Ga, 1100Gb, . . . ) communicates with one or more user terminals 1500 and functions as a game server with the user terminals 1500 serving as game clients.

The portal server system 1100P and the game server system 1100G can implement basic functions as computer systems in the same manner. That is, the portal server system 1100P is a computer system that includes a main body device 1101, a keyboard 1106, a touch panel 1108, and a storage 1140. The game server system 1100G is also a computer system having a similar configuration. The main body device 1101 incorporates a control board 1150 that includes various microprocessors such as a central processing section (CPU) 1151, a graphics processing section (GPU), and a digital signal processor (DSP), various IC memories 1152 such as a VRAM, a RAM, and a ROM, and electronic components such as a communication device 1153, and the like. The control board 1150 may be entirely or partially implemented by an application specific integrated circuit (ASIC), a field-programmable gate array (FPGA), or a system on a chip (SoC).

However, the portal server system 1100P and the game server system 1100G each implement their own separate functions by the control board 1150 performing calculation processes based on predetermined programs and data.

FIG. 1 illustrates the portal server system 1100P and each game server system 1100G as if they were one server device, but they may be implemented by a plurality of devices. For example, the portal server system 1100P and the game server system 1100G may include a plurality of blade servers each of which is responsible for each function, and may be connected to each other via an internal bus so as to be capable of data communication. The installation location of hardware constituting the portal server system 1100P and the game server systems 1100G does not matter. A plurality of independent servers installed at separate locations may perform data communication with each other via the network 9, thereby functioning as the portal server system 1100P or the game server system 1100G as a whole.

Each user terminal 1500 is a computer system that is used by a user to utilize the cyberspace control system 1000. The user terminal 1500 functions as a man-machine interface (MMIF) in the cyberspace control system 1000.

FIG. 1 illustrates a device called a smartphone as the user terminal 1500. However, the user terminal 1500 may take the form of a portable game device, a stationary consumer game device, a controller for a consumer game device, an arcade game apparatus, a personal computer, a tablet computer, a wearable computer, and the like. When a plurality of electronic devices, such as a combination of a smartphone and a smartwatch or a head-mounted display communicatively connected to the smartphone, are communicably connected together to perform one function, the plurality of electronic devices can be regarded as one user terminal 1500.

The user terminal 1500 includes a touch panel 1506 that functions as an operation input device and an image display device, and a control board 1550. The user terminal 1500 may be configured with a keyboard, a game controller, a mouse, or the like as an operation input device, for example, or may be configured with a head-mounted display, a glass-type display, or the like as an image display device, for example.

The control board 1550 includes various microprocessors such as a CPU 1551, a GPU, and a DSP, various IC memories 1552 such as a VRAM, a RAM, and a ROM, a communication module 1553 for connecting to the network 9, and the like. These elements included in the control board 1550 are electrically connected through a bus circuit or the like so that the elements can read and write data and exchange signals. The control board 1550 may partially or entirely be implemented by an ASIC, an FPGA, or an SoC.

In the control board 1550, the IC memory 1552 stores programs and various types of data for implementing the functions of the user terminal. The user terminal 1500 executes a predetermined application program to function as an MMIF of the cyberspace control system 1000 and as a game client. The application program and data required for its execution are downloaded from the portal server system 1100P at an appropriate timing. The application program and data may be read from a storage medium such as a memory card obtained separately by the user.

### Details

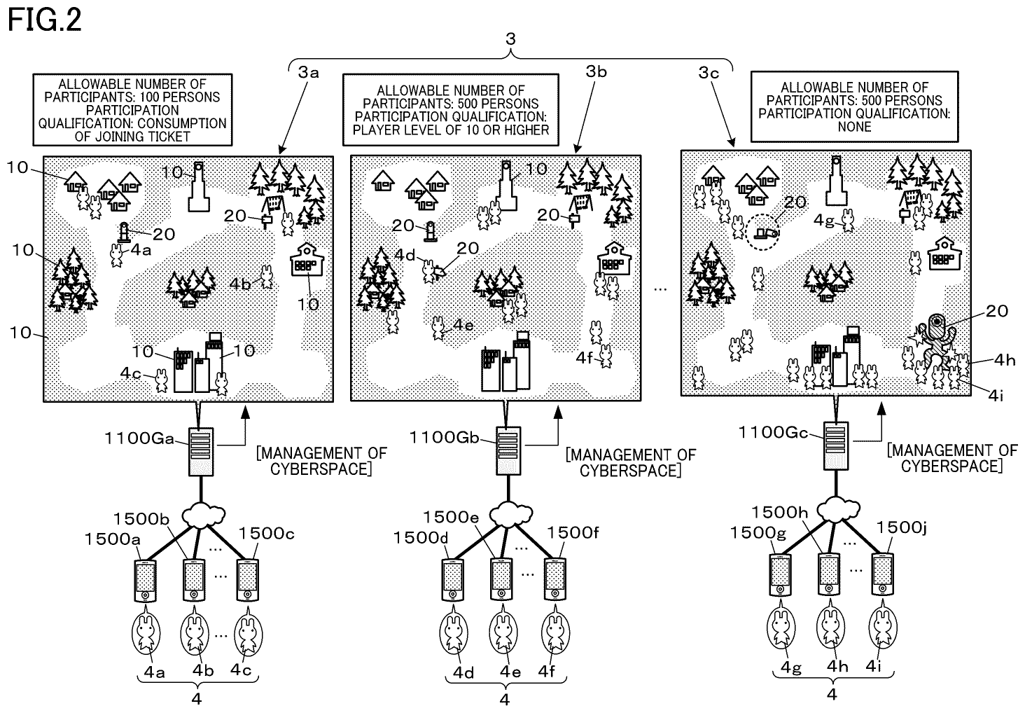

FIG. 2 is a diagram for describing cyberspace 3 provided by the cyberspace control system 1000. In the present embodiment, the cyberspace 3 is set as a three-dimensional virtual world (virtual space) that expresses a common world view (common game world) for all users. The cyberspace 3 has a space and time flow different from the real ones, and continues to exist as data of the cyberspace control system 1000 even when the user does not log in. Time passes in the cyberspace along with the passage of time in the real world, and control is performed so that the cyberspace 3 continues to change.

In the cyberspace 3, the cyberspace 3 includes a plurality of cyberspaces 3 (3a, 3b, . . . ) that exist simultaneously in parallel. Each game server system 1100G (1100Ga, 1100Gb, . . . ) stores and manages data of one cyberspace 3 (3a, 3b, . . . ). Although each cyberspace 3 (3a, 3b, . . . ) has an independent entity as data, the cyberspaces 3 are the same in size, position coordinate system, and rules applied, and they have a common world view. That is, the cyberspaces 3 (3a, 3b, . . . ) are the same in basic settings such as geography, background, and spatial coordinates as if each cyberspace 3 is the same to the user's side.

Specifically, disposed in each cyberspace 3 (3a, 3b, . . . ) are objects, broadly speaking, such as basic objects 10, background objects 20, and user characters 4 (4a, 4b, . . . ) of users participating in the cyberspace 3.

The basic objects 10 are objects for making the users recognize that they have logged into the cyberspace 3 having a common world view even if they have logged into different game server systems 1100G. For example, the basic objects 10 include objects representing terrain (or structures equivalent thereto), buildings, ruins, dungeon entrances, and the like.

The background objects 20 are objects that are not classified into the user characters 4 or the basic objects 10. For example, the background objects 20 include objects that the user characters 4 or various non-player characters (NPCs) can place, move, and remove at will, objects whose states the user characters 4 can change, and objects that appear when an event occurs.

A user operates his/her user terminal 1500 to log in to the portal server system 1100P, selects a cyberspace 3 (3a, 3b, . . . ) managed by one of the game server systems 1100G (1100Ga, 1100Gb, . . . ) as a joining destination, and participates in a game there. The game server system 1100G (1100Ga, 1100Gb, . . . ) disposes and makes the user character 4 of the participating user appear in the cyberspace 3 managed by the game server system 1100G. The game server system 1100G controls the action of the user character 4 in the cyberspace 3 according to the user's operation input, and changes the cyberspace 3 by making the objects constituting the cyberspace 3 appear, move, change the form, or erase as a result of the action. That is, the user can participate as the user character 4 in the cyberspace 3 managed by the game server system 1100G to which the user logged in using the user terminal 1500, and enjoy a virtual experience in the cyberspace 3.

The allowable number of participants (capacity) is set for each cyberspace. Therefore, the user cannot participate in a cyberspace in which the allowable number of participants has been reached at the time of login. When a new user logs in, the portal server system 1100P executes a participation possibility determination process of determining whether to permit the user as a determination target user to participate in each cyberspace. Then, the portal server system 1100P determines the joining destination for the user from among the cyberspaces in which participation is allowed. For example, the portal server system 1100P receives an operation to select a joining destination and determines the joining destination according to the desire of the determination target user.

In the present embodiment, the user can leave the current cyberspace (the cyberspace in which the user participated before leaving will be called “first cyberspace” as appropriate) by performing an inter-space movement operation, and participate in a second cyberspace different from the first cyberspace (that is, move between cyberspaces). When the user moves between cyberspaces by performing an inter-space movement operation, the participation allowed state of the user in the first cyberspace is set as appropriate.

However, the user cannot move to any cyberspace. The user cannot participate in a cyberspace in which the allowable number of participants has been reached at the time of the inter-space movement operation, so the user will instead participate in a cyberspace in which the allowable number of participants has not yet been reached.

This will be specifically described. When detecting an inter-space movement operation by a user participating in any one of the cyberspaces, the portal server system 1100P executes a participation possibility determination process for the user as a determination target user. Then, the portal server system 1100P determines a movement destination of the user from among the cyberspaces in which participation is allowed. For example, the portal server system 1100P accepts a selection operation of a movement destination and determines the movement destination according to the desire of the determination target user.

After determining the joining destination or movement destination, the portal server system 1100P assigns the determination target user to the game server system 1100G that manages the cyberspace. Accordingly, the user character of the determination target user is disposed in the cyberspace that is the joining destination or the movement destination.

### 1. About Participation Possibility Determination Process

In the present embodiment, as illustrated in FIG. 2, in addition to the above-described allowable number of participants (capacity), a participation qualification is set to each cyberspace managed by each game server system 1100G. The participation qualification can be set as a required player level, a type of item, a charged amount, or a combination of these, for example.

In the participation possibility determination process, the portal server system 1100P executes the following procedure for each cyberspace. That is, the portal server system 1100P first determines whether the participation allowed state in the cyberspace is set for the determination target user. If the participation allowed state is set, the portal server system 1100P determines that the participation of the determination target user in the cyberspace is allowed, and ends the determination of participation possibility related to the cyberspace.

On the other hand, if the participation allowed state is not set, the portal server system 1100P determines that “participation beyond the allowable number of participants in the cyberspace is impossible” as a first participation disallowance condition. Specifically, the portal server system 1100P determines that participation is allowed if there is a vacancy in the capacity based on the setting of the allowable number of participants in the cyberspace, and determines that participation is not allowed if there is no vacancy.

The determination on whether there is a vacancy in the capacity is basically made based on whether the number of users (participants) participating in the cyberspace at the time of determination reaches the allowable number of participants. In the present embodiment, however, there may be a user who is not participating in the cyberspace at the time of determination but is set to the participation allowed state in the cyberspace. Therefore, in determining the first participation disallowance condition, first, the number of users (number of users scheduled to participate) who are set to the participation allowed state in the cyberspace is obtained. Then, the number of users scheduled to participate is subtracted from the allowable number of participants to determine whether participation is possible. For example, the effective allowable number is obtained by subtracting the number of users scheduled to participate from the allowable number of participants, and if the number of participants does not reach the effective allowable number, it is determined that participation is possible, and if the number of participants does reach the effective allowable number, it is determined that participation is impossible. If it is determined that participation is impossible, the portal server system 1100P does not allow the determination target user to participate in the cyberspace, and ends the determination on participation in the cyberspace.

Then, for each cyberspace determined to be available for participation based on the first participation disallowance condition, the portal server system 1100P determines that “participation of a user without a participation qualification is not possible” as a second participation disallowance condition. Specifically, based on the setting of the participation qualification for the cyberspace, the portal server system 1100P determines that participation is possible if the determination target user has a participation qualification, and determines that participation is not possible if the user has no participation qualification. If it is determined that participation is possible, the portal server system 1100P allows the determination target user to participate in the cyberspace and ends the determination on participation in the cyberspace. If it is determined that participation is impossible, the portal server system 1100P does not allow the determination target user to participate in the cyberspace, and ends the determination on participation in the cyberspace.

For example, in the example of FIG. 2, if there is a vacancy in the cyberspace 3a, a newly logged-in user or a user who has performed an inter-space movement operation can participate in the cyberspace 3a in exchange for consuming a joining ticket. On the other hand, if there is a vacancy in a cyberspace that does not require a participation qualification, such as the cyberspace 3c, the user can participate in the cyberspace.

In this example, all users for whom the participation allowed state is set are allowed to participate, regardless of their participation qualification. However, even for users for whom the participation allowed state is set, the second participation disallowance condition may be re-determined, and participation may be allowed only if the user has a participation qualification at the time of the re-determination.

### 2. About Setting Participation Allowed State

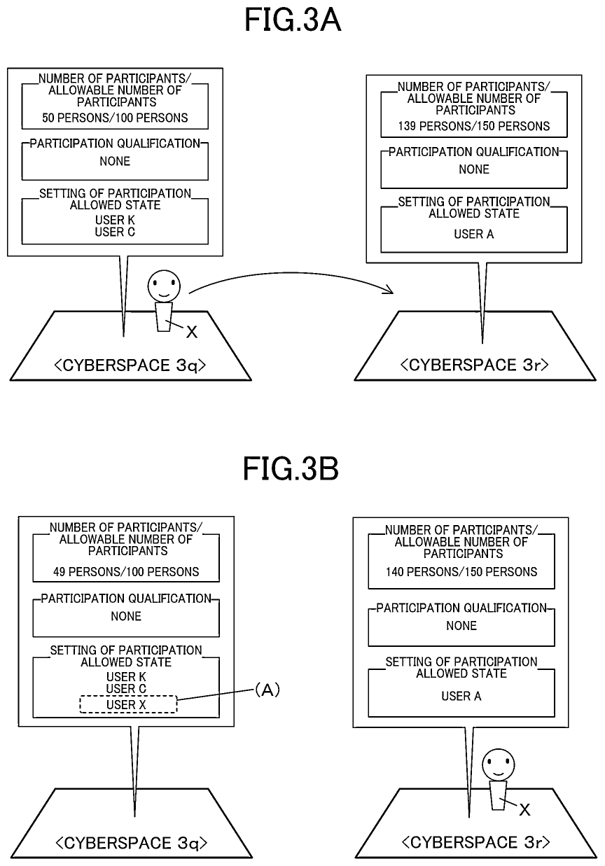

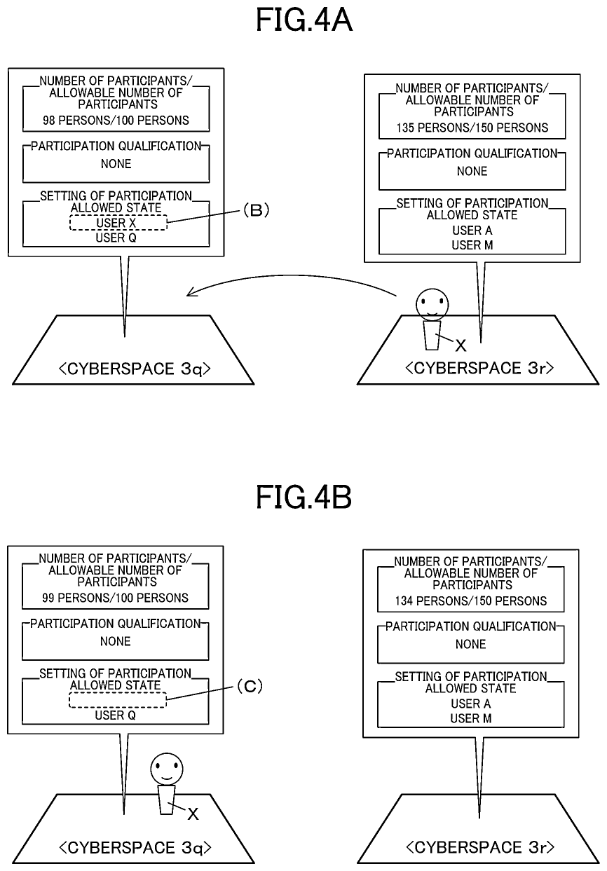

FIGS. 3A and 3B and 4A and 4B are diagrams for describing an overview of setting of the participation allowed state. When a user participating in a first cyberspace leaves the first cyberspace, which is any one of the cyberspaces, the portal server system 1100P sets the participation allowed state in the first cyberspace for the user.

There are two types of leaving from a cyberspace: (1) leaving when moving to a different cyberspace (second cyberspace) from the current cyberspace, and (2) leaving when temporarily suspending the game and logging out from the portal server system 1100P. A user participating in any cyberspace (first cyberspace) can perform (1) leaving the first cyberspace by performing an inter-space movement operation at any time, or perform (2) leaving the first cyberspace by performing a log-out operation at any time.

By performing the process, the user who was set to the participation allowed state when leaving the first cyberspace is allowed to participate in the first cyberspace in the subsequent participation possibility determination process. In other words, setting the participation allowed state makes it possible to ensure that the user is reserved for participation in the first cyberspace. This can prevent a situation in which when the user moves to the second cyberspace and then attempts to participate in the first cyberspace again, the first cyberspace is full and the user is unable to participate, and can ensure that the user can participate in the first cyberspace. The same can be said when the user logs out once to interrupt the game and then logs in again.

For example, referring to FIG. 3A, it is assumed that a user X participating in a cyberspace 3q (first cyberspace) performs an inter-space movement operation and selects a cyberspace 3r (second cyberspace) as the movement destination. Since there is a vacancy in the capacity of the cyberspace 3r and participation qualification is not required, the user X's participation in the cyberspace 3r is allowed in the participation possibility determination process. In this case, the portal server system 1100P sets the participation allowed state of the cyberspace 3q for the user X ((A) in FIG. 3B). Then, after the setting, the portal server system 1100P controls the user X to leave the cyberspace 3q, and allows the user X to participate in the cyberspace 3r as illustrated in FIG. 3B. Since the participation allowed state is set before the user leaves the cyberspace 3q, the participation allowed state can be set reliably.

In addition, it is assumed that the user X performs an inter-space movement operation in the state of FIG. 4A after that. In the example of FIG. 4A, the number of participants has increased from the state of FIG. 3B, and there is no vacancy in the capacity of the cyberspace 3q. That is, the number of participants has not reached the allowable number of participants, but has reached the effective allowable number because two people are set to the participation allowed state. However, since the participation allowed state in the cyberspace 3q is set for the user X at the time of the movement in FIG. 3 ((B) of FIG. 4A), the user X′s participation in the cyberspace 3q is allowed in the participation possibility determination process. In this case, the portal server system 1100P controls the user X to leave the cyberspace 3r, and allows the user X to participate in the cyberspace 3q as illustrated in FIG. 4B. Then, since the user X returns to the cyberspace 3q, the portal server system 1100P cancels the setting of the participation allowed state for the user X in cyberspace 3q ((C) of FIG. 4B).

The above is an overview of the setting of the participation allowed state. In the present embodiment, however, the setting is performed conditionally. Therefore, when a user leaves any cyberspace (first cyberspace), the portal server system 1100P executes a specific user certification process for certifying the specific user and a participation allowed state setting process for setting the participation allowed state.

### 2-1. About Specific User Certification Process

In the specific user certification process, the portal server system 1100P determines whether a user who leaves the first cyberspace, as a certification target user, satisfies a certification condition. Then, the portal server system 1100P certifies the user who satisfies the certification condition as a specific user.

The cyberspace in which it is determined that the user mainly participates is called “main participation space”. In the specific user certification process of the present embodiment, it is determined whether the first cyberspace is the main participation space for the certification target user based on the certification condition. If the certification condition is satisfied, the certification target user is certified as a specific user in the first cyberspace.

For example, a cyberspace where a user plays a game for a certain amount of time can be said to be the main participation space for the certification target user. Thus, the certification condition is determined based on the participation time of the certification target user in the first cyberspace. The certification condition can be set as “participation time is a predetermined time or more (for example, 100 hours or more)”. The participation time may be measured as the time of continuous participation in the first cyberspace, or may be measured as the total time of participation in the first cyberspace in the past, or may be measured as the time of participation in the first cyberspace within a certain period of time from the past to the present.

Note that the certification condition may be determined based on the number of times the certification target user participated in the first cyberspace. In this case, the certification condition may be set, for example, as “the number of participation counts is a predetermined number or more (for example, 20 times or more)”. Alternatively, the certification condition may be determined based on the frequency at which the certification target user participates in the first cyberspace. In this case, the certification condition may be set, for example, as “the frequency of participation is 10 times or more in the last 10 days”. When the number of participation counts in the first cyberspace is large or the frequency of participation is high, the cyberspace can also be said to be the main participation space, just like when the participation time is long.

The certification condition may be determined based on the action of the certification target user in the first cyberspace. For example, the certification condition may be set based on the gameplay status. In this case, the gameplay status may include the number of items acquired as a result of gameplay in the first cyberspace, whether a specific item has been obtained, the number of events or missions completed, whether a specific event or the like has been cleared, a history of dialogue with other user characters, and the like, for example. Focusing on the acquisition of items, if the certification target user has acquired a predetermined number of items or more in gameplay in the first cyberspace, or if the user has acquired a rare item that cannot be acquired without playing the game to a certain extent, the first cyberspace can be said to be the main participation space for the certification target user. The same can be said for a case where the user has completed many events or a specific event, or a case where the user has talked to other user characters a lot.

In addition, it may be determined whether a user satisfies the certification condition using the relationship between users. Examples of the relationship between users include a friend relationship, a relationship between members of the same guild, and the like. The certification condition may be set as “a predetermined number or more of the friends of the certification target user participate in the first cyberspace” or the like, for example. This is because a cyberspace in which many friends participate can be the main participation space for the certification target user. The same applies to a case where a certification condition based on the number of guild members is set.

Furthermore, the certification of a specific user may not be performed based on whether the first cyberspace is the main participation space for the certification target user. For example, in contrast to the above, the certification target user may be certified as a specific user if the time of participation in the first cyberspace is short, the number of participation counts is small, or the frequency of participation is low.

In addition, a specific user may not be certified by determining the time of participation, the number of participation counts, or the frequency of participation in relation to the cyberspace from which the specific user is leaving, but may be certified by determining the total participation time, the total number of participation counts, or the total frequency of participation in any cyberspace.

### 2-2. About Participation Allowed State Setting Process

In the participation allowed state setting process, when a user (certification target user) who leaves the first cyberspace is certified as a specific user as a result of the specific user certification process, the portal server system 1100P sets the participation allowed state for the user (specific user) in the participation possibility determination process to participate in the first cyberspace. This allows the user to participate at any time in the first cyberspace from which he/she has left, unless the set participation allowed state is canceled.

### 3. About Participation Allowed State Cancel Process

In the participation allowed state cancel process, the portal server system 1100P cancels the participation allowed state that was set in the participation allowed state setting process. In the participation allowed state cancel process of the present embodiment, the portal server system 1100P cancels the participation allowed state based on the lapse time since the participation allowed state was set in the participation allowed state setting process. For example, a predetermined cancel time is set in advance, and when the lapse time reaches the cancel time, the setting is canceled.

The participation allowed state may be cancelled based on the lapse time since the specific user left the first cyberspace. For example, when the lapse time reaches a predetermined cancel time, the setting is cancelled.

In addition, after the specific user who has been set to the participation allowed state in the participation allowed state setting process leaves the first cyberspace related to the participation allowed state, the setting of the participation allowed state may be canceled while the user is participating in the second cyberspace that is different from the first cyberspace.

In the present embodiment, the participation allowed state is set by determining when the user leaves the main participation space. However, depending on the participation status in the cyberspace after that, the main participation space of the specific user related to the participation allowed state may change. For example, in the example of FIG. 3, if the user X who moved to the cyberspace 3r continues to participate in the cyberspace 3r for a long time, the main participation space of the user X is no longer the cyberspace 3q but the cyberspace 3r.

Therefore, it may be determined whether to cancel the setting of the participation allowed state based on the time during which the specific user related to the participation allowed state has participated in the second cyberspace other than the first cyberspace related to the participation allowed state after the participation allowed state has been set. For example, the setting of the participation allowed state may be canceled when the user has continuously participated in a cyberspace other than the first cyberspace for a predetermined time (for example, 100 hours).

The determination may be made not based on the duration of continuous participation but based on the total duration of participation. In addition, the determination may not be made based on the duration of participation in a specific cyberspace, but may be made based on the duration of participation in any cyberspace other than the first cyberspace.

Alternatively, it may be determined whether to cancel the participation allowed state based on the actions performed in the second cyberspace by the specific user related to the participation allowed state.

For example, it is determined whether to cancel the participation allowed state based on the gameplay status in the second cyberspace of the specific user related to the participation allowed state. Specifically, the setting of the participation allowed state is canceled when the second cyberspace can be said to be the main participation space for the specific user related to the participation allowed state based on the number and types of items acquired as a result of gameplay in the second cyberspace, the number and types of events completed, the history of dialogue with other user characters, and the like.

### Functional Configuration

### 1. Portal Server System

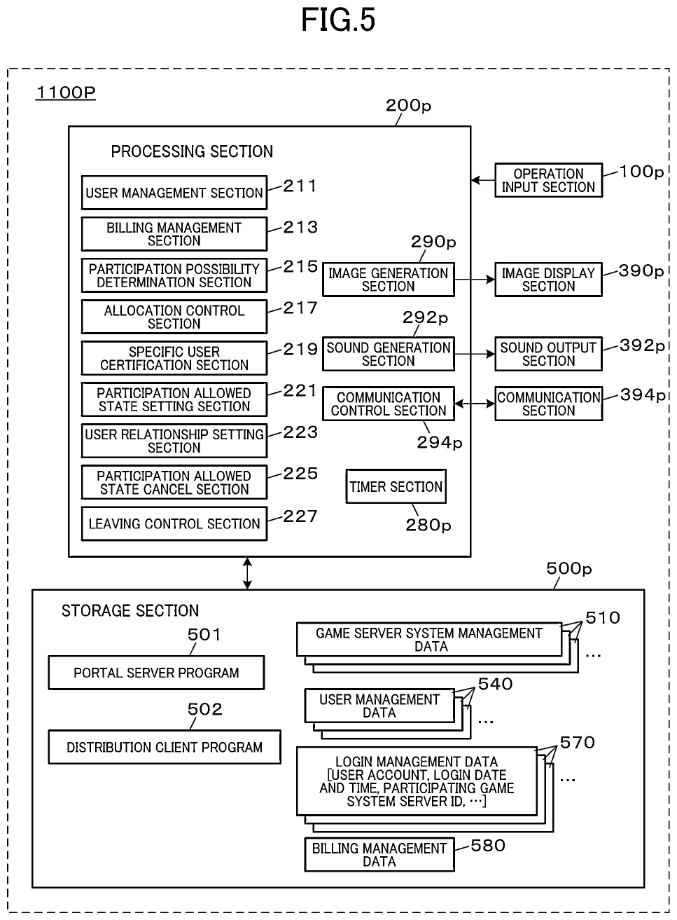

FIG. 5 is a block diagram illustrating an example of a functional configuration of the portal server system 1100P. As illustrated in FIG. 5, the portal server system 1100P of the present embodiment includes an operation input section 100p, a processing section 200p, an image display section 390p, a sound output section 392p, a communication section 394p, and a storage section 500p.

The operation input section 100p is a means for inputting various operations for managing the portal server system 1100P, and can be implemented by a keyboard, a mouse, a touch panel, or the like, for example. In the example of FIG. 1, the operation input section 100p corresponds to the keyboard 1106 and the touch panel 1108 in FIG. 1.

The processing section 200p can be implemented by a processor including an arithmetic circuit such as a CPU, a GPU, an ASIC, or an FPGA, and an electronic component such as an IC memory, for example. The processing section 200p controls input/output of data between device sections including the operation input section 100p and the storage section 500p. The processing section 200p performs various calculation processes based on predetermined programs and data, operation input signals from the operation input section 100p, data received from the game server system 1100G (1100Ga, 1100Gb, . . . ) and the user terminals 1500, and the like, and comprehensively controls the operation of the portal server system 1100P. In the example of FIG. 1, the processing section 200p corresponds to the control board 1150 and the CPU 1151 thereon.

The processing section 200p includes a user management section 211, a billing management section 213, a participation possibility determination section 215, an allocation control section 217, a specific user certification section 219, a participation allowed state setting section 221, a user relationship setting section 223, a participation allowed state cancel section 225, a leaving control section 227, a timer section 280p, an image generation section 290p, a sound generation section 292p, and a communication control section 294p.

The user management section 211 performs a process related to a user registration procedure, and stores and manages various types of information associated with a user account.

The billing management section 213 performs various controls related to the implementation of billing elements such as the usage fee for the cyberspace control system 1000 and the purchase of items that can be used in the game.

The participation possibility determination section 215 is a functional section that executes a participation possibility determination process. The participation possibility determination section 215 determines whether to allow the participation of a determination target user in each cyberspace managed by each of the plurality of game server systems 1100G (1100Ga, 1100Gb, . . . ) based on a participation disallowance condition associated with the cyberspace.

The allocation control section 217 performs control to allocate users who wish to participate in the cyberspace to the game server systems 1100G of the cyberspaces in which the participation possibility determination section 215 has determined that the users are allowed to participate. The game server system 1100G to which each user is to be allocated is determined by receiving the user's selection operation of a joining destination or a movement destination from among the cyberspaces in which the participation is determined to be allowed, for example.

The specific user certification section 219 is a functional section that executes a specific user certification process. The specific user certification section 219 certifies a user who satisfies a given certification condition as a specific user.

The participation allowed state setting section 221 is a functional section that executes a participation allowed state setting process. When a user (a certification target user) who leaves one of the plurality of cyberspaces (first cyberspace) is certified as a specific user by the specific user certification section 219, the participation allowed state setting section 221 sets a participation allowed state in which the participation possibility determination section 215 allows the specific user to participate in the first cyberspace.

The user relationship setting section 223 registers friends in accordance with the user's registration operation, and sets friend relationships with other users. The user relationship setting section 223 also registers guilds in accordance with the user's registration operation, and sets guild relationships with other users.

The participation allowed state cancel section 225 is a functional section that executes a participation allowed state cancel process. The participation allowed state cancel section 225 cancels the participation allowed state set by the participation allowed state setting section 221.

The leaving control section 227 is a functional section that controls a user to leave a cyberspace. The leaving control section 227 controls the user to leave the cyberspace after the participation allowed state setting section 221 has completed setting of the participation allowed state.

The timer section 280p utilizes a system clock to perform various types of time measurements such as a current date and time or a limited time period.

The image generation section 290p generates image signals of various management screens for system management of the portal server system 1100P, and outputs them to the image display section 390p.

The sound generation section 292p is implemented by executing an IC or software that generates and decodes sound data. The sound generation section 292p outputs the generated sound signal to the sound output section 392p.

The communication control section 294p performs communication connection and data processing for data communication with external devices (for example, the game server system 1100G and the user terminal 1500) via the communication section 394p, thereby to implement the exchange of data with the external devices.

The image display section 390p displays various screens based on the image signals input from the image generation section 290p. For example, the image display section 390p can be implemented by an image display device such as a flat panel display, a projector, or a head-mounted display. The image display section 390p corresponds to the touch panel 1108 in the example of FIG. 1.

The sound output section 392p receives the sound signals input from the sound generation section 292s to emit corresponding sounds. The sound output section 392p corresponds to a speaker (not illustrated) included in the main body device 1101 or the touch panel 1108 in the example of FIG. 1.

The communication section 394p connects to the network 9 to implement communication. For example, the communication section 394p can be implemented by a wireless communication device, a modem, a terminal adaptor (TA), a jack for wired communication cable, or a control circuit. The communication section 394p corresponds to the communication device 1153 in the example of FIG. 1.

The storage section 500p stores in advance or temporarily stores each time processing is performed, programs for operating the portal server system 1100P and implementing various functions of the portal server system 1100P, and data used during execution of the programs. For example, the storage section 500p can be implemented by an IC memory such as a RAM or a ROM, a magnetic disk such as a hard disk, or an optical disk such as a CD-ROM or a DVD. The storage section 500p corresponds to the IC memory 1152 and the storage 1140 in the example of FIG. 1.

The storage section 500p also stores a portal server program 501, a distribution client program 502, game server system management data 510, user management data 540, login management data 570, and billing management data 580. In addition, the storage section 500p stores necessary data such as a timer, a counter, various tables and thresholds, and flags as appropriate.

The portal server program 501 is a program for causing the processing section 200p to function as the user management section 211, the billing management section 213, the participation possibility determination section 215, the allocation control section 217, the specific user certification section 219, the participation allowed state setting section 221, the user relationship setting section 223, the participation allowed state cancel section 225, and the leaving control section 227. The portal server program 501 may also include programs for causing the processing section 200p to function as the image generation section 290p, the sound generation section 292p, and the communication control section 294p.

The distribution client program 502 is the original of the client program provided to the user terminals 1500 and executed therein.

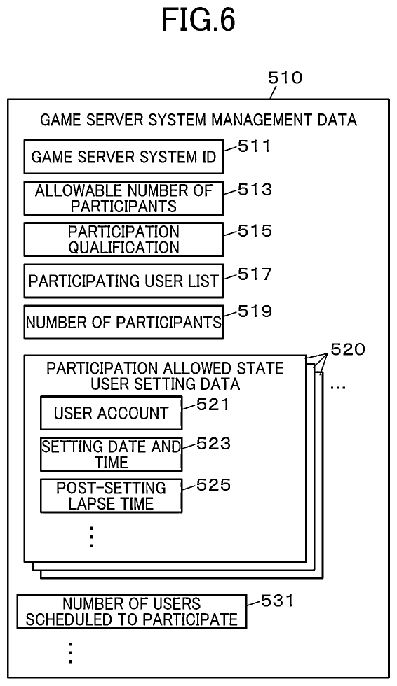

The game server system management data 510 is prepared for each of the plurality of game server systems 1100G (1100Ga, 1100Gb, . . . ) and stores various types of data related to the cyberspace managed by the game server system 1100G. For example, in one game server system management data 510, a game server system ID 511 indicating the game server system 1100G that is the managing entity, an allowable number of participants 513 related to the first participation disallowance condition, and a participation qualification 515 related to the second participation disallowance condition are set in advance, as illustrated in FIG. 6. In addition, in the game server system management data 510, a participating user list 517, number of participants 519, participation allowed state user setting data 520, and number of users scheduled to participate 531 are set and updated as needed.

The participating user list 517 stores a list of users who are participating in the cyberspace among the users who have logged in to the portal server system 1100P. The number of participants 519 includes the number of users set in the participating user list 517.

The participation allowed state user setting data 520 is prepared for each user (specific user) who has been set to the participation allowed state in the cyberspace. One piece of participation allowed state user setting data 520 includes a user account 521 of the specific user, setting date and time 523 when the participation allowed state in the cyberspace was set for the specific user, and a post-setting lapse time 525 that is the time elapsed since the setting date and time 523, for example. The number of users scheduled to participate 531 includes the number of users for which the participation allowed state in the cyberspace was set (the number of settings in the participation allowed state user setting data 520).

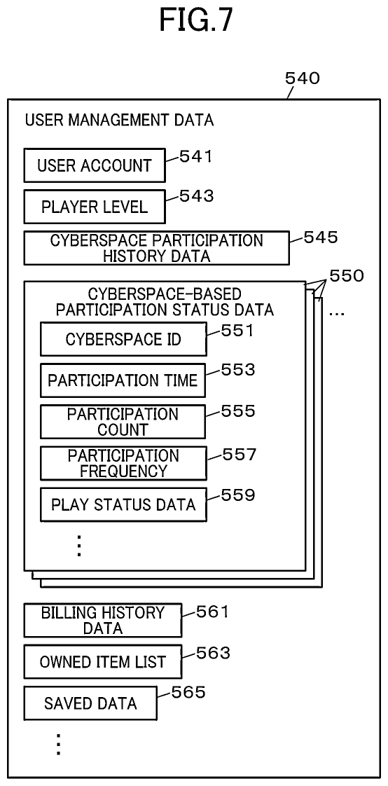

The user management data 540 is prepared for each user who has completed the registration procedure, and is managed by the user management section 211. For example, as illustrated in FIG. 7, one piece of user management data 540 includes a user account 541 of the user, a player level 543 that is automatically determined according to the gameplay results of the user, cyberspace participation history data 545, cyberspace-based participation status data 550, billing history data 561 of the user, a list of items owned by the user 563 such as joining tickets, and game saved data 565. The saved data 565 includes setting data for a user character used by the user, and the like.

The cyberspace participation history data 545 stores the history indicating when the user participated in which of the cyberspaces managed by each game server system 1100G (1100Ga, 1100Gb, . . . ).

The cyberspace-based participation status data 550 is prepared for each cyberspace in each game server system 1100G and includes various types of data related to the participation status of the user in the cyberspace. For example, in one piece of cyberspace-based participation status data 550, participation time 553, number of participation count 555, participation frequency 557, play status data 559, and the like that are used for certifying whether the user is a specific user are set in association with a cyberspace ID 551 indicating the cyberspace.

The play status data 559 includes the types and number of items the user has acquired while playing the game in the cyberspace, the types of events and missions the user has completed, and history of dialogue with other user characters. The user management section 211 acquires the latest information on the user's gameplay in the cyberspace from the game server system 1100G in the cyberspace, and updates the cyberspace-based participation status data 550.

The login management data 570 is prepared for each logged-in user, and includes various types of data related to the login status of users in the entire cyberspace control system 1000.

The billing management data 580 includes various types of data related to billing. For example, the billing management data 580 includes service usage fees, item-specific fees, and inventory information.

### 2. Game Server System

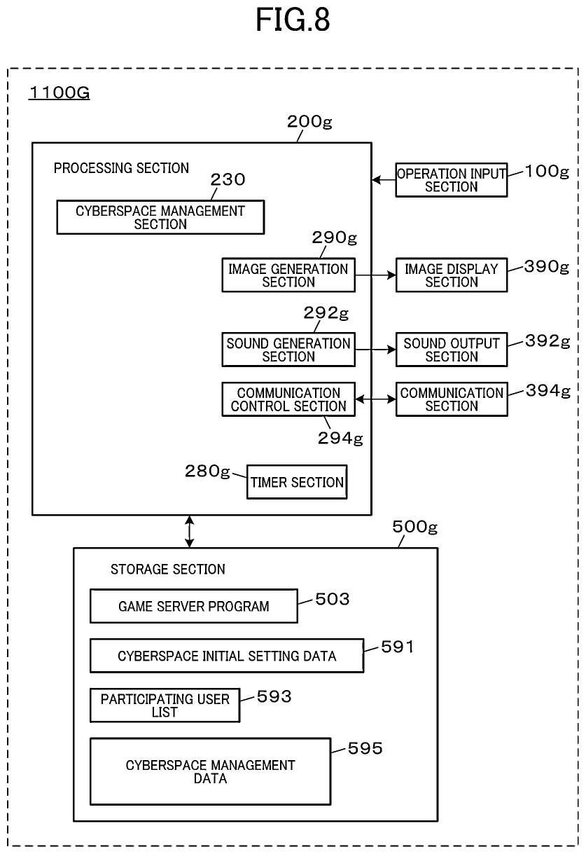

FIG. 8 is a block diagram illustrating an example of a functional configuration of the game server system 1100G (1100Ga, 1100Gb, . . . ). As illustrated in FIG. 8, the game server system 1100G of the present embodiment includes an operation input section 100g, a processing section 200g, an image display section 390g, a sound output section 392g, a communication section 394g, and a storage section 500g.

The operation input section 100g is a means for inputting various operations for managing the game server system 1100G, and can be implemented by a keyboard, a mouse, a touch panel, or the like, for example.

The processing section 200g can be implemented by a processor including an arithmetic circuit such as a CPU, a GPU, an ASIC, or an FPGA, and an electronic component such as an IC memory, for example. The processing section 200g controls input/output of data between device sections including the operation input section 100g and the storage section 500g. The processing section 200g performs various calculation processes based on predetermined programs and data, operation input signals from the operation input section 100g, data received from the portal server system 1100P and the user terminals 1500, and the like, and comprehensively controls the operation of the game server system 1100G.

The processing section 200g includes a cyberspace management section 230, a timer section 280g, an image generation section 290g, a sound generation section 292g, and a communication control section 294g.

The cyberspace management section 230 executes various controls related to the construction and management of cyberspace. In the present embodiment, the cyberspace management section 230 in each game server system 1100G executes the following processes. This implements the construction and management of a virtual space (game space) set in a common world view in which user characters appear, as a cyberspace in which users assigned to the game server system 1100G participate.

For example, the cyberspace management section 230 can perform the following processes related to the progress control of the game in the game space and reflection of the play results: 1) a process of disposing basic objects and background objects in a virtual three-dimensional space to form a game space, 2) a process of disposing user characters in the game space and controlling the user characters in response to operation inputs at the user terminals 1500, 3) a process of automatically controlling a virtual camera and enemy characters, 4) a process related to hit determination and damage determination of an attack and reflection thereof, 5) a process related to determination of acquisition and use of an item and reflection thereof, 6) a process of controlling the occurrence of an event or mission and its progress, 7) a process of generating an image of the game space seen from the virtual camera (game image), 8) a process of determination on whether the game end condition has been satisfied, and the like. In addition, along with each process, various types of data required for managing the cyberspace-based participation status data 550 is transmitted to the portal server system 1100P as needed.

The timer section 280g utilizes a system clock to perform various types of time measurements such as a current date and time or a limited time period.

The image generation section 290g generates image signals of various management screens for system management of the game server system 1100G, and outputs them to the image display section 390g.

The sound generation section 292g is implemented by executing an IC or software that generates and decodes sound data. The sound generation section 292g outputs the generated sound signal to the sound output section 392g.

The communication control section 294g performs communication connection and data processing for data communication with external devices (for example, the portal server system 1100P and the user terminal 1500) via the communication section 394g, thereby to implement the exchange of data with the external devices.

The image display section 390g displays various screens based on the image signals input from the image generation section 290g. For example, the image display section 390g can be implemented by an image display device such as a flat panel display, a projector, or a head-mounted display.

The sound output section 392g receives the sound signals input from the sound generation section 292g to emit corresponding sounds.

The communication section 394g connects to the network 9 to implement communication. For example, the communication section 394g can be implemented by a wireless communication device, a modem, a terminal adaptor (TA), a jack for wired communication cable, or a control circuit.

The storage section 500g stores in advance or temporarily stores each time processing is performed, programs for operating the game server system 1100G and implementing various functions of the game server system 1100G, and data used during execution of the programs. For example, the storage section 500g can be implemented by an IC memory such as a RAM or a ROM, a magnetic disk such as a hard disk, or an optical disk such as a CD-ROM or a DVD.

The storage section 500g also stores a game server program 503, cyberspace initial setting data 591, a participating user list 593, and cyberspace management data 595. In addition, the storage section 500g stores necessary data such as a timer, a counter, various tables and thresholds, and flags as appropriate.

The game server program 503 is a program for causing the processing section 200g to function as the cyberspace management section 230. The game server program 503 may also include programs for causing the processing section 200g to function as the image generation section 290g, the sound generation section 292g, and the communication control section 294g.

The cyberspace initial setting data 591 includes various types of data defining the initial state of the cyberspace, and the initial states of various objects such as basic objects, background objects, and user characters that appear in the cyberspace and various types of data required for display and motion control of these objects according to the types of the objects. Since the cyberspace in the present embodiment is a game space, the cyberspace initial setting data 591 can also be said to be game initial setting data. The cyberspace initial setting data 591 also includes various types of setting data related to game rules.

The participating user list 593 includes a list of users who have been allocated to the game server system 1100G by the portal server system 1100P and are participating in the cyberspace of the game server system 1100G.

The cyberspace management data 595 includes various types of data describing the latest state of the cyberspace managed by the game server system 1100G. For example, the cyberspace management data 595 includes the positions, postures, ability parameter values, character status, and the like of various objects in the virtual space, and the like.

### 3. User Terminal

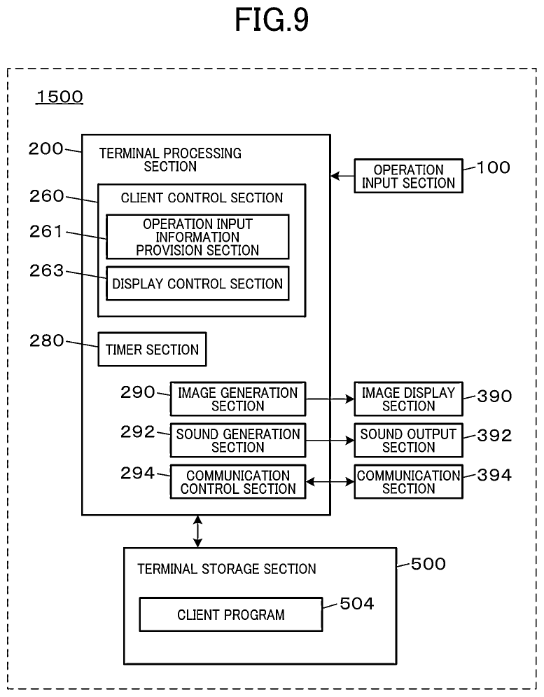

FIG. 9 is a functional block diagram illustrating an example of a functional configuration of the user terminal 1500. The user terminal 1500 includes an operation input section 100, a terminal processing section 200, an image display section 390, a sound output section 392, a communication section 394, and a terminal storage section 500.

The operation input section 100 outputs operation input signals in accordance with various operation inputs by the user to the terminal processing section 200. The operation input section 100 can be implemented, for example, by a push switch, a joystick, a touch pad, a track ball, an accelerometer, or a gyro.

The terminal processing section 200 can be implemented, for example, by a processor including an arithmetic circuit such as a CPU, a GPU, an ASIC, or an FPGA, and an electronic component such as an IC memory. The terminal processing section 200 controls input/output of data between device sections including the operation input section 100 and the terminal storage section 500. The terminal processing section 200 performs various calculation processes based on predetermined programs and data, operation input signals from the operation input section 100, data received from the portal server system 1100P and the game server system 1100G, and the like, and comprehensively controls the operation of the user terminal 1500. In the example of FIG. 1, the terminal processing section 200 corresponds to the control board 1550 and the CPU 1551 thereon.

The terminal processing section 200 includes a client control section 260, a timer section 280, an image generation section 290, a sound generation section 292, and a communication control section 294.

The client control section 260 performs various controls to cause the user terminal 1500 to function as a man-machine interface (MMIF) as a game client in the cyberspace control system 1000. The client control section 260 includes an operation input information provision section 261 and a display control section 263.

The operation input information provision section 261 performs control to transmit operation input information to the game server system 1100G and the portal server system 1100P in response to an input from the operation input section 100.

The display control section 263 performs control for displaying game images on the image display section 390 based on the data received from the game server system 1100G.

The timer section 280 utilizes a system clock to perform time measurements such as a current date and time or a limited time period.

The image generation section 290 generates and outputs an image signal for displaying an image on the image display section 390 under the control of the client control section 260. The image generation section 290 corresponds to the graphics processing unit (GPU), a graphic controller, a graphics board, and the like mounted on the control board 1550 in the example of FIG. 1.

The sound generation section 292 is implemented by a processor such as a digital signal processor (DSP) or a sound synthesizing IC, or an audio codec for playing a sound file, for example. The sound generation section 292 generates sound signals for music, sound effects, and various types of operational sounds and outputs the generated sound signals to the sound output section 392.

The communication control section 294 performs communication connection and data processes for data communication with external devices (for example, the portal server system 1100P and the game server system 1100G) via the communication section 394, thereby implementing the exchange of data with the external devices.

The image display section 390 displays various screens such as a game screen based on the image signals input from the image generation section 290. For example, the image display section 390 can be implemented by an image display device such as a flat panel display, a projector, or a head-mounted display.

The sound output section 392 emits sounds such as sound effects or BGM related to the game, based on the sound signals input from the sound generation section 292.

The communication section 394 connects to the network 9 to implement communication. For example, the communication section 394 can be implemented by a wireless communication device, a modem, a terminal adaptor (TA), a jack for wired communication cable, or a control circuit. The communication section 394 corresponds to the communication module 1553 in the example of FIG. 1.

The terminal storage section 500 stores programs for causing the user terminal 1500 to operate to implement various functions included in the user terminal 1500 and data used during the execution of the programs. The programs and the data are stored previously or temporarily at every process. For example, the terminal storage section 500 can be implemented by an IC memory such as a RAM or a ROM, a magnetic disk such as a hard disk, or an optical disk such as a CD-ROM or a DVD. The terminal storage section 500 corresponds to the IC memory 1552 mounted on the control board 1550 in the example of FIG. 1.

The terminal storage section 500 also stores a client program 504 (application program) for causing the user terminal 1500 to function as the client control section 260, and a current date and time 900. Of course, the terminal storage section 500 can also store other data as appropriate.

### Flow of Process

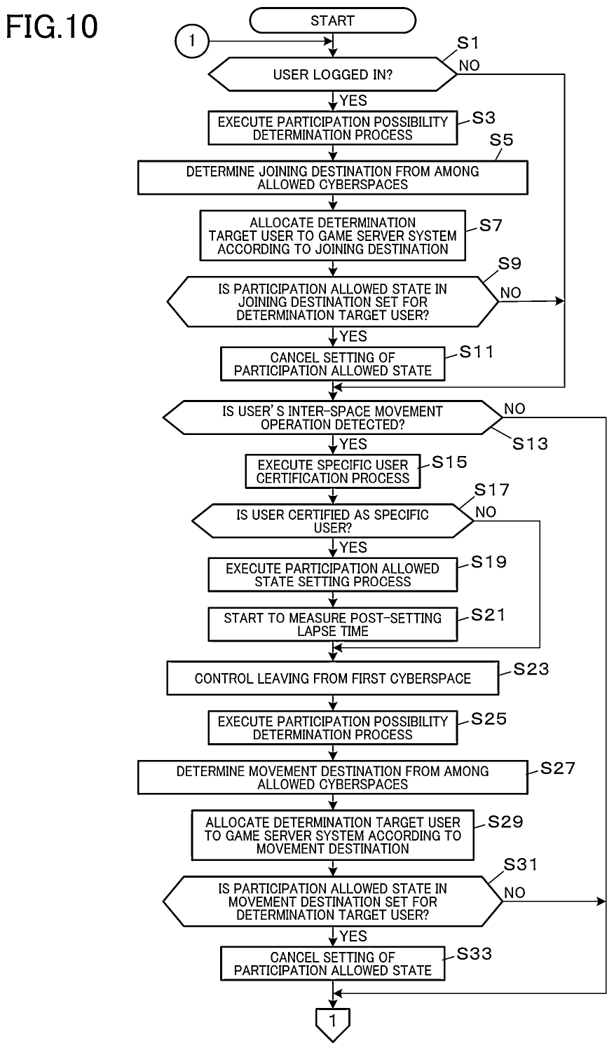

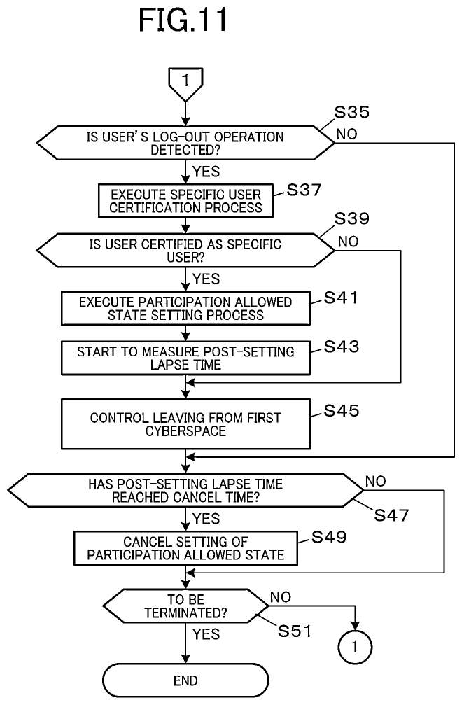

FIGS. 10 and 11 are flowcharts showing the flow of process in the portal server system 1100P. The process described here is implemented by the processing section 200p reading and executing the portal server program 501.

As shown in FIG. 10, in the portal server system 1100P, when a user logs in (step S1: YES), the participation possibility determination section 215 executes a participation possibility determination process (step S3). The participation possibility determination section 215 determines whether to allow the participation of the logged-in user as a determination target user in each cyberspace of each game server system 1100G (1100Ga, 1100Gb, . . . ).

Next, the allocation control section 217 determines a joining destination from among the cyberspaces for which participation was allowed as a result of the participation possibility determination process in step S3 (step S5), and allocates the determination target user to the game server system 1100G in the cyberspace that is the joining destination (step S7).

Then, when the participation allowed state in the joining destination determined in step S5 is set for the determination target user, that is, when the participation allowed state user setting data 520 in which the user account 521 indicates the determination target user is set in the game server system management data 510 related to the cyberspace that is the joining destination (step S9: YES), the participation allowed state cancel section 225 cancels the setting of the participation allowed state (step S11). This cancel can be performed by deleting the participation allowed state user setting data 520.

When an inter-space movement operation of a user participating in any one of the cyberspaces (first cyberspace) is detected (step S13: YES), the specific user certification section 219 executes a specific user certification process (step S15). If the user who performed the inter-space movement operation satisfies the certification condition, the specific user certification section 219 certifies the user as a specific user.

If the user is certified as a specific user as a result of the specific user certification

process in step S15 (step S17: YES), the participation allowed state setting section 221 executes the participation allowed state setting process to set the specific user to a participation allowed state in the first cyberspace (step S19). Then, the participation allowed state cancel section 225 starts a timer to start measuring the post-setting lapse time 525 related to the participation allowed state (step S21). The post-setting lapse time 525 is the time elapsed from the time of setting in step S19. Then, the process proceeds to step S23. Also, if the specific user is not certified (step S17: NO), the process proceeds to step S23.

In step S23, the leaving control section 227 controls the leaving of the user who performed the inter-space movement operation from the first cyberspace. In order to determine the movement destination, the participation possibility determination section 215 executes a participation possibility determination process on the user as a determination target user (step S25). The participation possibility determination section 215 determines whether to allow the determination target user to participate in each cyberspace of each game server system 1100G.

Next, the allocation control section 217 determines a movement destination from among the cyberspaces for which participation was allowed as a result of the participation possibility determination process in step S25 (step S27), and allocates the determination target user to the game server system 1100G in the cyberspace that is the movement destination (step S29).

Then, when the participation allowed state in the movement destination determined in step S27 is set for the determination target user, that is, when the participation allowed state user setting data 520 in which the user account 521 indicates the determination target user is set in the game server system management data 510 related to the cyberspace that is the movement destination (step S31: YES), the participation allowed state cancel section 225 cancels the setting of the participation allowed state (step S33).

As shown in FIG. 11, when a log-out operation of a user participating in any one of the cyberspaces (first cyberspace) is detected (step S35: YES), the specific user certification section 219 executes a specific user certification process (step S37). If the user who performed the log-out operation satisfies the certification condition, the specific user certification section 219 certifies the user as a specific user.

If the user is certified as a specific user as a result of the specific user certification

process in step S37 (step S39: YES), the participation allowed state setting section 221 executes the participation allowed state setting process to set the specific user to a participation allowed state in the first cyberspace (step S41). Then, the participation allowed state cancel section 225 starts a timer to start measuring the post-setting lapse time 525 (the time elapsed from the time of setting in step S41) related to the participation allowed state (step S43). Then, the process proceeds to step S45. If the specific user is not certified (step S39: NO), the process proceeds to step S45.

In step S45, the leaving control section 227 controls the leaving of the user who performed the inter-space movement operation from the first cyberspace. Thereafter, a process is carried out for the user to log out from the portal server system 1100P.

When the post-setting lapse time since time measurement was started in step S21 (that is, the value of the post-setting lapse time 525 related to the participation allowed state since the participation allowed state that was set in step S19 and was not canceled in step S11, step S33, or subsequent step S49 (where the participation allowed state user setting data 520 is set)), or the post-setting lapse time since time measurement was started in step S43 (similarly, the value of the post-setting lapse time 525 related to the participation allowed state where the participation allowed state user setting data 520 is set) has reached the cancel time (step S47: YES), the setting of the participation allowed state is canceled (step S49).

Then, until this process is terminated (step S51: NO), the process returns to step S1 in FIG. 10 and the above-described steps are repeated.

As described above, according to the present embodiment, when a user who leaves the first cyberspace is certified as a specific user, the specific user can be set to the participation allowed state in the first cyberspace. This prevents a situation in which the number of participants increases while the specific user leaves the first cyberspace and the specific user cannot return to the first cyberspace. In other words, even if the specific user leaves the first cyberspace in which the specific user currently resides, the specific user can reliably participate in the first cyberspace when he/she wishes later, as long as the participation allowed state set for the specific user is not cancelled. For example, the specific user can leave the first cyberspace when he/she wants to temporarily move to another virtual space where an event that has already been completed in the current virtual space has not yet occurred, or when he/she wants to participate in another virtual space where a friend is participating, and then can return to the first cyberspace. Therefore, it is possible to implement a mechanism in which a user can easily move between a plurality of cyberspaces where the number of participants is limited.

In the above embodiment, when a user (specific user) who has been allowed to participate in the cyberspace (first cyberspace) by being set to the participation allowed state participates in the first cyberspace after that, the participation allowed state of the specific user is cancelled. Alternatively, the cancellation may not be performed. In this case, the participation allowed state may be canceled when a predetermined time has elapsed without the specific user re-participating in the first cyberspace after the participation allowed state is set. This can be implemented by measuring the lapse time since the specific user last left the first cyberspace related to the participation allowed state, and then canceling the state when the predetermined time has elapsed.

In the above embodiment, a specific user is certified by determining whether the first cyberspace from which the user left can be considered as a main participation space, and a participation allowed state of the specific user in the first cyberspace is set. In contrast, when a user leaves any cyberspace (first cyberspace), the participation allowed state in the first cyberspace may be set for the specific user regardless of the relationship between the specific user and the first cyberspace.

In the above embodiment, the game space (virtual space) of a multiplayer online game is exemplified as the cyberspace. However, the present disclosure can be similarly applied to the management of various cyberspaces shared by a plurality of users. For example, the present disclosure can be similarly applied to the management of a virtual space such as a metaverse where users communicate with each other via avatars, or a chat room where participating users communicate by sending and receiving text data. In this case, the virtual space such as the metaverse or the chat room is the cyberspace. A plurality of users share one cyberspace, thereby enabling communication between the users.

When the present disclosure is applied to management of a chat room, a specific user may be certified based on the number of comments made in the chat room. For example, when a user leaves a certain chat room, if the number of comments made in the chat room exceeds a predetermined number, the user may be certified as a specific user who satisfies the certification conditions. Conversely, if the number of comments made is less than the predetermined number, the user may be certified as a specific user who satisfies the certification condition. Similarly, after the participation allowed state is set, if the number of comments made by the specific user in another chat room exceeds a predetermined number, the setting of the participation allowed state may be canceled.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A computer system comprising at least one processor or circuit programmed to execute:
managing a plurality of cyberspaces associated with a participation disallowance condition including at least a condition that participation by users in excess of a given allowable number of participants is disallowed;
performing a participation possibility determination for determining whether the users are allowed to participate in the cyberspaces based on the participation disallowance condition associated with the cyberspaces; and
when a given specific user participating in a first cyberspace among the cyberspaces leaves the first cyberspace, performing a participation allowed state setting control to set the participation of the specific user in the first cyberspace to a participation allowed state that is allowed by the participation possibility determination.

2. The computer system as defined in claim 1, wherein the plurality of cyberspaces are virtual spaces set in a common world view where the characters of participating users appear.

3. The computer system as defined in claim 1, wherein the performing a participation possibility determination includes determining whether the specific user for which the participation allowed state was set by the participation allowed state setting control, is allowed to participate in a cyberspace other than the first cyberspace based on the participation disallowance condition associated with the cyberspace.

4. The computer system as defined in claim 1, wherein the performing a participation possibility determination includes determining whether the user is allowed to participate in the first cyberspace while subtracting the number of specific users set in the participation allowed state from the allowable number of participants included in the participation disallowance condition associated with the first cyberspace.

5. The computer system as defined in claim 1, wherein the at least one processor or circuit is further programmed to execute performing specific user certification to certify a user who satisfies a given certification condition as the specific user.

6. The computer system as defined in claim 5, wherein the performing specific user certification includes determining whether the user satisfies the certification condition based on any one of a duration of participation, the number of participation counts, and a frequency of participation in the first cyberspace.

7. The computer system as defined in claim 5, wherein the performing specific user certification includes determining whether the user satisfies the certification condition based on the user's action in the first cyberspace.

8. The computer system as defined in claim 5,
wherein the at least one processor or circuit is further programmed to execute establishing a relationship between users, and
wherein the performing specific user certification includes determining whether the user satisfies the certification condition by using the relationship between the users.

9. The computer system as defined in claim 1, wherein the performing participation allowed state setting control includes canceling the setting of the participation allowed state for the specific user.

10. The computer system as defined in claim 9, wherein the canceling includes determining whether to cancel the setting of the participation allowed state for the specific user based on a lapse time since the participation allowed state was set for the specific user or a lapse time since the specific user left the first cyberspace.

11. The computer system as defined in claim 9, wherein the canceling includes canceling the setting of the participation allowed state for the specific user while the specific user is participating in a second cyberspace among the cyberspaces.

12. The computer system as defined in claim 11, wherein the canceling includes determining whether to cancel the setting of the participation allowed state for the specific user based on the time when the specific user participated in the second cyberspace or an action taken by the specific user in the second cyberspace.

13. The computer system as defined in claim 1, wherein the at least one processor or circuit is further programmed to execute, after completion of the setting by the participation allowed state setting control, performing control to cause the specific user to leave the first cyberspace.

14. A cyberspace control system comprising:
a server system that is the computer system as defined in claim 1; and
a user terminal that acts as a man-machine interface for a user.

15. A management method executed by a computer system, the method comprising:
managing a plurality of cyberspaces associated with a participation disallowance condition including at least a condition that participation by users in excess of a given allowable number of participants is disallowed;
performing a participation possibility determination for determining whether the users are allowed to participate in the cyberspaces based on the participation disallowance condition associated with the cyberspaces; and
when a given specific user participating in a first cyberspace among the cyberspaces leaves the first cyberspace, performing a participation allowed state setting control to set the participation of the specific user in the first cyberspace to a participation allowed state that is determined in the performing a participation possibility determination.
